(19) United States
(12) Patent Application Publication
(10) Pub. No.: US 2012/0050204 A1
(43) Pub. Date: Mar. 1, 2012

(54) TOUCH PANEL WITH IMPEDANCE ADJUSTING STRUCTURE AND IMPEDANCE ADJUSTING METHOD THEREOF

(76) Inventors: Wu-Tung KAO, Taichung City (TW); Chih-Ping Shu, Taichung City (TW); Chi-Feng Chiu, Taichung City (TW)

(21) Appl. No.: 12/870,520

(22) Filed: Aug. 27, 2010

(51) Int. Cl. G06F 3/045

(52) U.S. Cl. 345/174

(57) ABSTRACT

A touch panel of a display has an impedance adjusting structure for enhancing the detection precision of touch points and includes a transparent substrate, a transparent electroconductive layer and an electrode pattern layer. The electrode pattern layer includes two parallel X-side electrodes and two parallel Y-side electrodes, which surround a rectangular area and are formed on a periphery portion of the electroconductive layer. Each of the X-side and Y-side electrodes is composed of carbon paste sections and silver paste sections arranged in a neighboring manner. Output currents of the X-side and Y-side electrodes are adjusted according to ratios of the carbon paste sections to the silver paste sections, wherein the carbon/silver paste sections are spaced apart by gaps, which are the same, ascend or descend. According to the design, the specific impedance adjustment of the electrode pattern layer can be performed according to the special requirement in the used environment.

### BACKGROUND OF THE INVENTION

1. Field of the Invention

The invention relates a touch panel with the impedance adjusting technology.

2. Related Art

The liquid crystal display has the advantages of the light weight, the small thickness, the small dimensions, the low radiation and the low power consumption, and thus becomes the mainstream product in the current market. Furthermore, the touch panel is disposed on a display screen, so that the user can perform the interactive input operation, and the friendliness of the communication interface between the human and the machine, and the input operation efficiency are enhanced.

FIGS. 1 and 2 show the structure of the conventional surface capacitive touch panel 10. The touch panel 10 has a transparent substrate 11, a transparent electroconductive layer 12 disposed above the transparent substrate 11, and an electrode pattern layer 13 disposed above the transparent electroconductive layer 12. The electrode pattern layer 13 includes two opposite X-side electrodes 131 and two opposite Y-side electrodes 132, all of which surround a rectangular area and are formed on a periphery portion of the transparent electroconductive layer 12. Furthermore, a hard layer 14 for insulation protection covers an upper surface of the electrode pattern layer 13. Regarding the operation architecture, the system generates one uniform electric field on the transparent electroconductive layer 12. When the finger touches the touch panel 10, the capacitor charging effect appears, and capacitor coupling is formed between the electrode pattern layer 13 of the touch panel 10 and the finger so that the capacitor change is generated. The controller only has to measure the current intensities at four corners so that the touch position may be calculated according to the current intensities.

Furthermore, although the surface capacitive technology has the advantage of easy production, its maximum limitation is that the multi-point touch function cannot be implemented, and the calibration operation has to be performed. In addition, the electromagnetic interference (EMI) and noise problems, which cause the signal to be too sensitive or weak and cannot be easily solved, still have to be overcome. According to the environmental factor observation, the EMI problem is a frequently seen design challenge, and becomes more complicated in the mobile phone with the complicated signals. The weather change is also a factor, which cannot be ignored. The touch sensing correctness is affected by the temperature, humidity or raining condition. When the impedance is too high, the poor touch phenomenon may be caused. If the impedance is too low, the too-sensitive problem is caused so that the signal may be mis-judged. So, the improper impedance affects the stability of the touch panel and the precision of the touch point detection.

### SUMMARY OF THE INVENTION

It is therefore an object of the invention to provide a touch panel with an impedance adjusting structure and an impedance adjusting method thereof, so that the specific impedance adjustment of the electrode pattern layer of the touch panel can be performed according to the special requirement of the used environment.

The invention achieves the above-identified object by providing a touch panel comprising a transparent substrate, a transparent electroconductive layer, an electrode pattern layer and a protection layer. The electrode pattern layer includes two opposite parallel X-side electrodes and two opposite parallel Y-side electrodes, which surround a rectangular area and are formed on a periphery portion of the electroconductive layer. Each of the X-side and Y-side electrodes is composed of one carbon paste section and one silver paste section, or carbon paste sections and silver paste sections arranged in a neighboring manner. Each of impedances of X-side and Y-side electrodes is adjusted according to a ratio of the carbon paste section(s) to the silver paste section(s). Each of end portions of the X-side electrodes and Y-side electrodes is electrically connected to a wire for measuring an output current.

Thus, the specific impedance adjustment of the electrode pattern layer in the touch panel of the invention can be performed according to the special requirement of the used environment, so that the consistency and stability of the touch point sensitivity can be held, and the precision of the detected position of the touch point of the touch panel can be enhanced. In addition, the simplest printing technology can be adopted to adjust the impedance so that the manufacturing processes may be significantly simplified, and the manufacturing cost thereof can be effectively reduced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematically and pictorially decomposed illustration showing the rough architecture of a conventional touch panel.

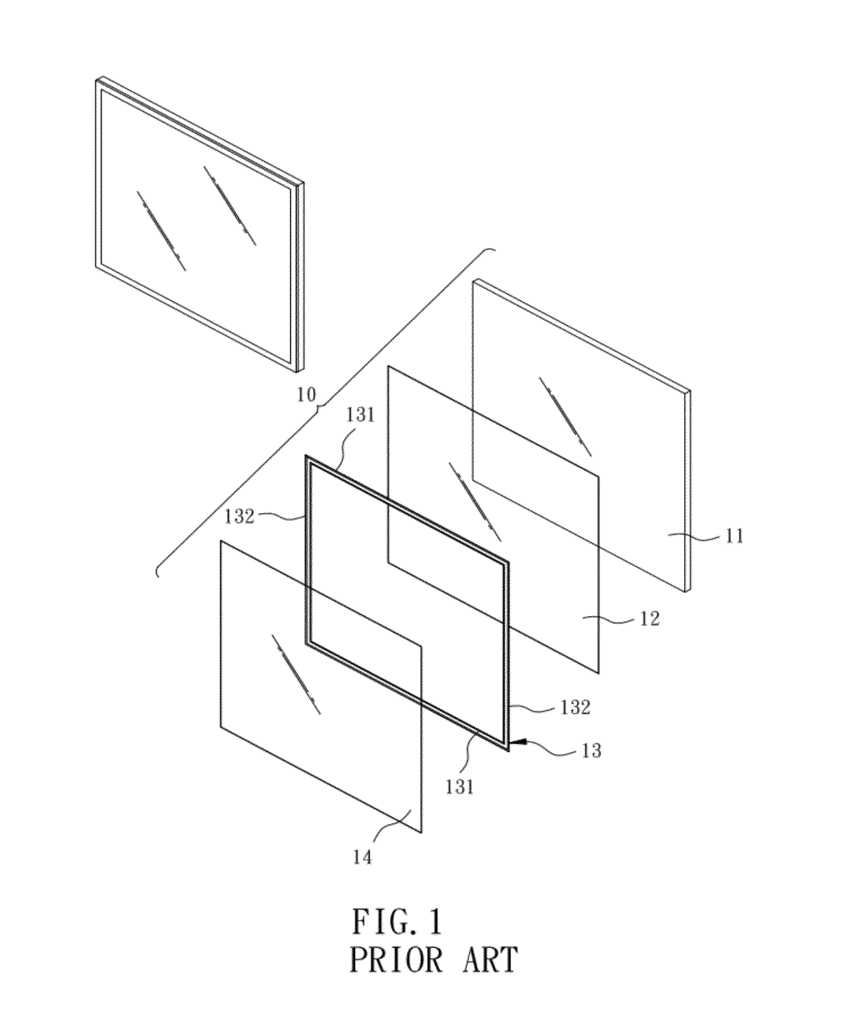

FIG. 2 is a schematic illustration showing a conventional touch panel, which receives a sensing signal to determine a position of a touch point.

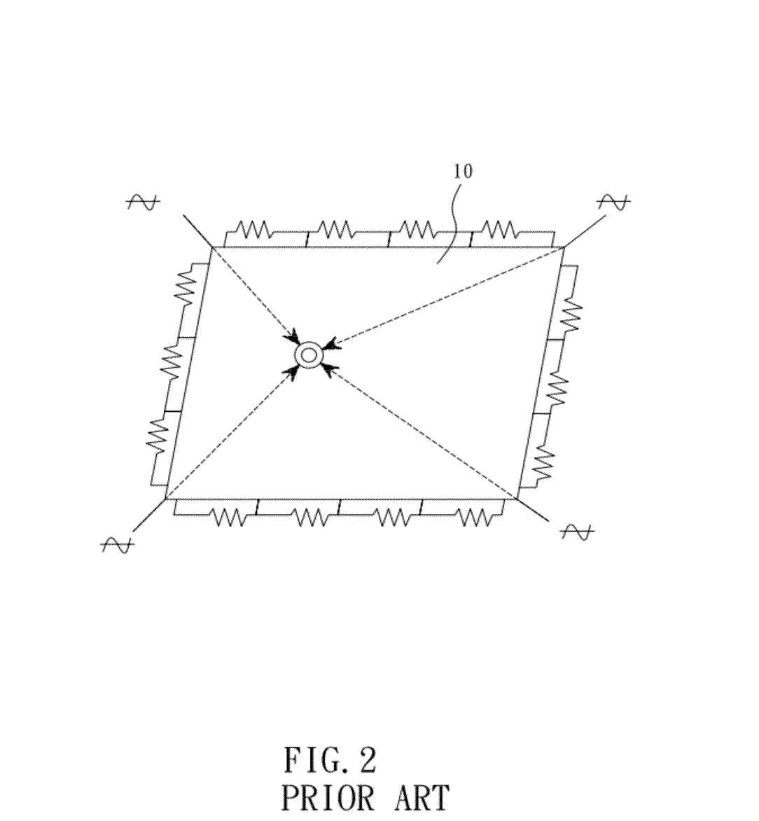

FIG. 3 is a schematically and pictorially decomposed illustration showing the rough architecture of a touch panel of the invention.

FIG. 4 is a schematic plane view showing the touch panel with the impedance adjusting structure according to the invention.

FIGS. 5A to 5C are schematic plane views showing the touch panels with impedance adjusting structures according to different embodiments of the invention.

FIGS. 6A to 6B are schematically cross-sectional views showing different structures for the touch panel with the impedance adjusting structure.

FIG. 7 is a schematic illustration showing the touch panel, which receives a sensing signal to determine multiple touch positions, according to the invention.

FIG. 8 is a schematic plane view showing a touch panel with an impedance adjusting structure according to another embodiment of the invention.

### DETAILED DESCRIPTION OF THE INVENTION

The present invention will be apparent from the following detailed description, which proceeds with reference to the accompanying drawings, wherein the same references relate to the same elements.

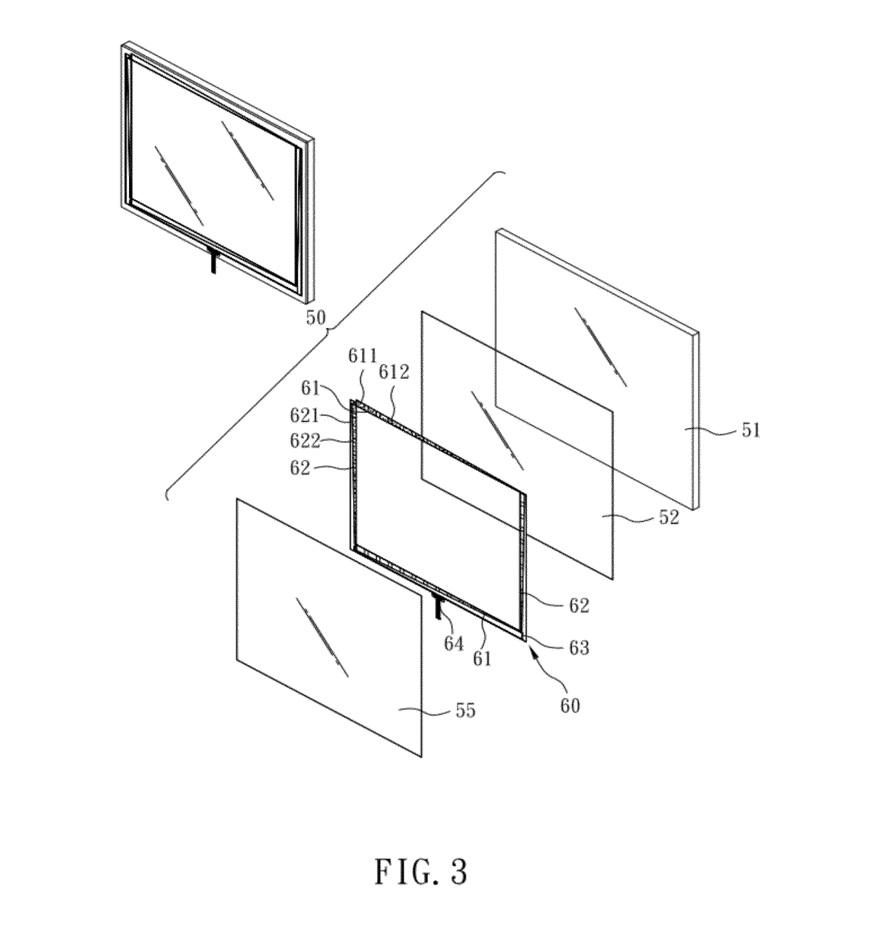

The invention provides a touch panel 50 with an impedance adjusting structure and an impedance adjusting method thereof. As shown in FIG. 3, the touch panel 50 adopts the surface capacitive touch technology, and includes a transparent substrate 51, a transparent electroconductive layer 52, an electrode pattern layer 60 and a protection layer 55 stacked together. The transparent substrate 51 may be a transparent glass substrate, a transparent plastic substrate or an indium tin oxide (ITO) electroconductive plastic film. The transparent electroconductive layer 52 may be an indium tin oxide film or an antimony tin oxide film, and the protection layer 55 may be a transparent insulative hard film, a mother glass film, a plastic film or the like.

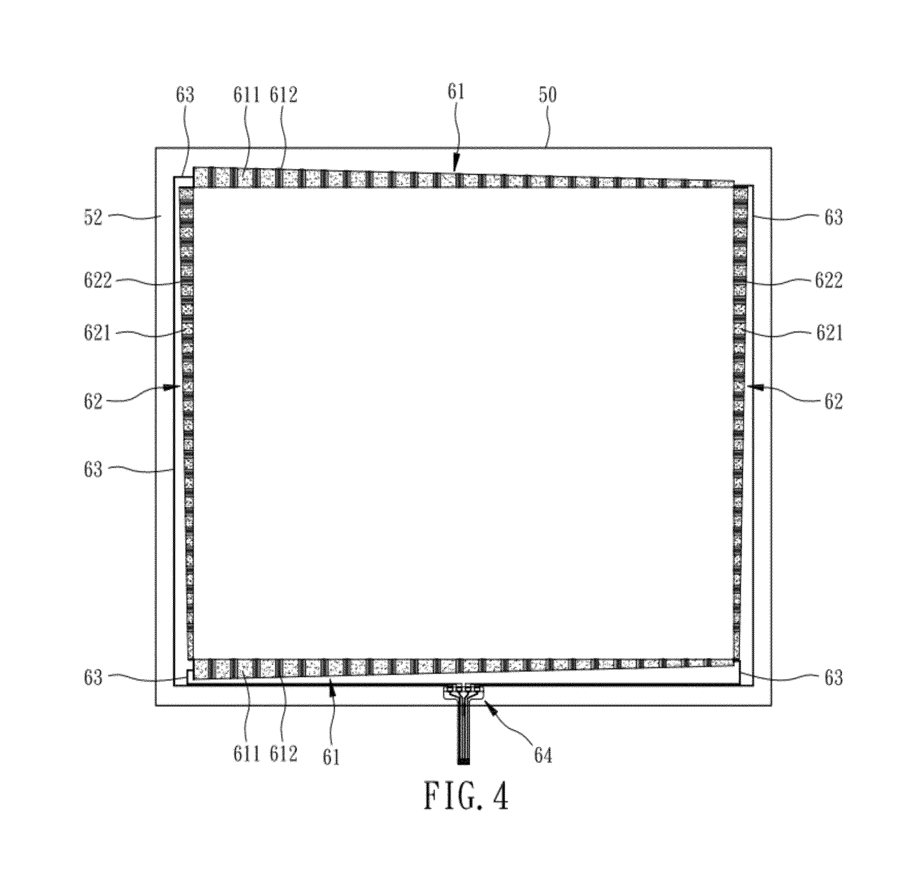

The detailed structure of the preferred embodiment of the invention is shown in FIGS. 3 and 4. The electrode pattern layer 60 includes two opposite parallel X-side electrodes 61 and two opposite parallel Y-side electrodes 62, all of which surround a rectangular area and are formed on a periphery portion of the transparent electroconductive layer 52. The impedances of the X-side electrode 61 and the Y-side electrode 62 of the electrode pattern layer 60 may be configured in an ascending manner or a descending manner with a common difference or a common ratio toward the same side, so that impedances of two touch points on the same horizontal or vertical line of the touch panel 50 have a gradient phenomenon to prevent currents, outputted from the electrode pattern layer 60, from offsetting each other when the two touch points are moved, and positions of the two different touch points are calculated according to the currents. A controller (not shown) is utilized to measure the current intensities at four corners so that the X and Y coordinates of the two different touch points are calculated according to the currents. In addition, the X-side and Y-side electrodes 61 and 62 of the electrode pattern layer 60 are formed on the periphery of the transparent electroconductive layer 52 of the touch panel 50 by way of etching, screen printing, electro-transfer printing or the like.

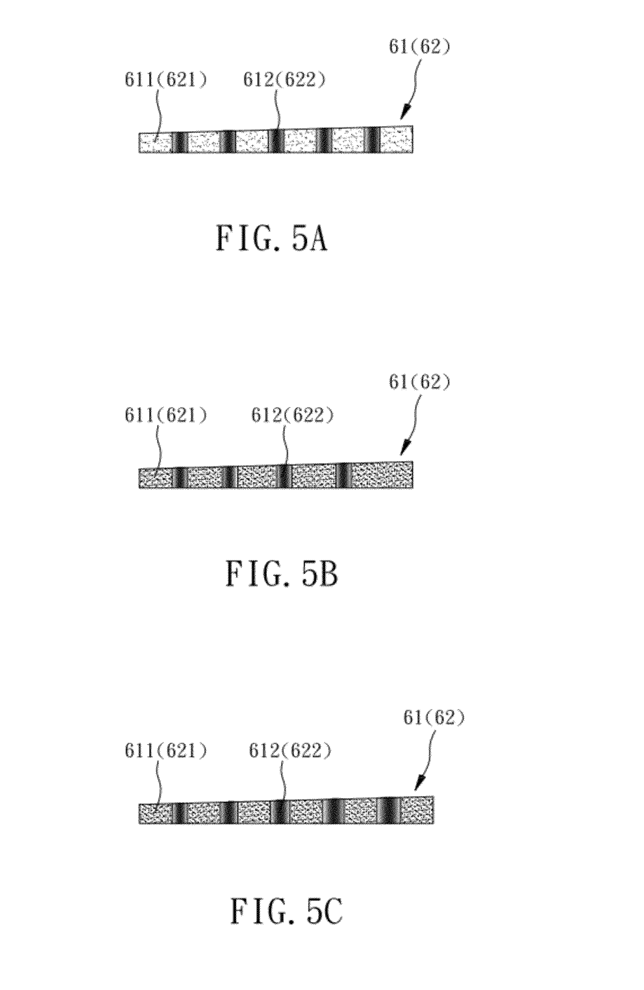

Furthermore, the X-side and Y-side electrodes 61, 62 of the electrode pattern layer 60 include one or more carbon paste sections 611, 621 and one or more silver paste sections 612, 622 arranged in a neighboring manner. The spaced carbon paste sections 611, 621 and the spaced silver paste sections 612, 622 may be spaced apart by constant gaps (see FIG. 5A). The spaced carbon paste sections 611, 621 are configured in an ascending manner or a descending manner with a common difference or a common ratio (see FIG. 5B), wherein the gaps between the carbon paste sections 611, 621 ascend or descend with the common difference or the common ratio. The spaced silver paste sections 612, 622 are configured in an ascending manner or a descending manner with a common difference or a common ratio (see FIG. 5C), wherein the gaps between the carbon paste sections 611, 621 ascend or descend with the common difference or the common ratio. According to the design of the X-side and Y-side electrodes 61, 62, the specific impedance adjustment of the electrode pattern layer 60 of the touch panel 50 can be performed according to the special requirement in the used environment. Thus, the consistency and stability of the sensitivity of the touch point can be enhanced so that the precision of the detected position of the touch point of the touch panel is enhanced.

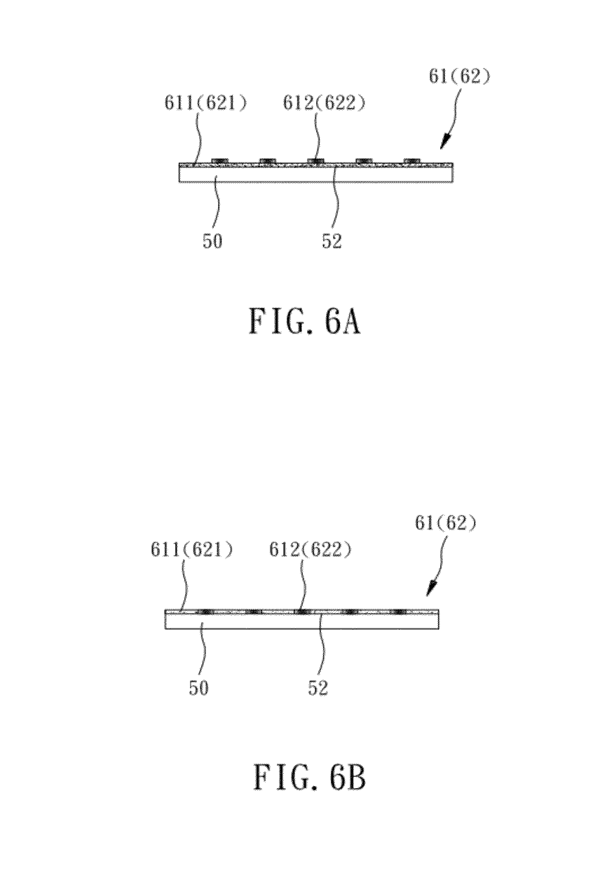

Furthermore, the carbon paste sections 611, 621 and the silver paste sections 612, 622 of the X-side and Y-side electrodes 61, 62 of the electrode pattern layer 60 may be formed in the manner shown in FIG. 6A. First, the complete carbon paste sections 611, 621 are formed on an edge of the transparent electroconductive layer 52 of the touch panel 50. Next, the silver paste sections 612, 622 are formed on the surfaces of the carbon paste sections 611, 621 in a spaced manner so that the impedances of the X-side and Y-side electrodes 61, 62 may be adjusted. Alternatively, as shown in FIG. 6B, the spaced carbon paste sections 611, 621 are firstly formed on the edge of the transparent electroconductive layer 52 of the touch panel 50. Next, the spaced silver paste sections 612, 622 are formed in the gaps between the carbon paste sections 611, 621 and on the surface of the transparent electroconductive layer 52, so that the impedances of the X-side and Y-side electrodes 61, 62 are adjusted.

In addition, the electrode pattern layer 60 may have four output terminals (see FIG. 4) or eight output terminals. The corresponding terminals of the X-side and Y-side electrodes 61 and 62 of the electrode pattern layer 60 are commonly provided with wires 63 each for measuring the voltage and the current. The wire 63 is made of the electroconductive material, such as the carbon paste, the silver paste, the copper paste or the mixtures thereof. In this invention, the silver paste is adopted, and the wires 63 are disposed on the surface of the non-work area of the touch panel 50 by way of screen printing. Also, the touch panel 50 also has a connection portion 64 for the layout of the other-side terminals of the wires 63 so that the wires 63 can be respectively electrically connected to a controller (not shown) of the touch panel 50.

Thus, the touch panel with the impedance adjusting structure can be obtained, wherein the impedance consistency and stability can be held, and the precision of the position of the detected touch point can be enhanced.

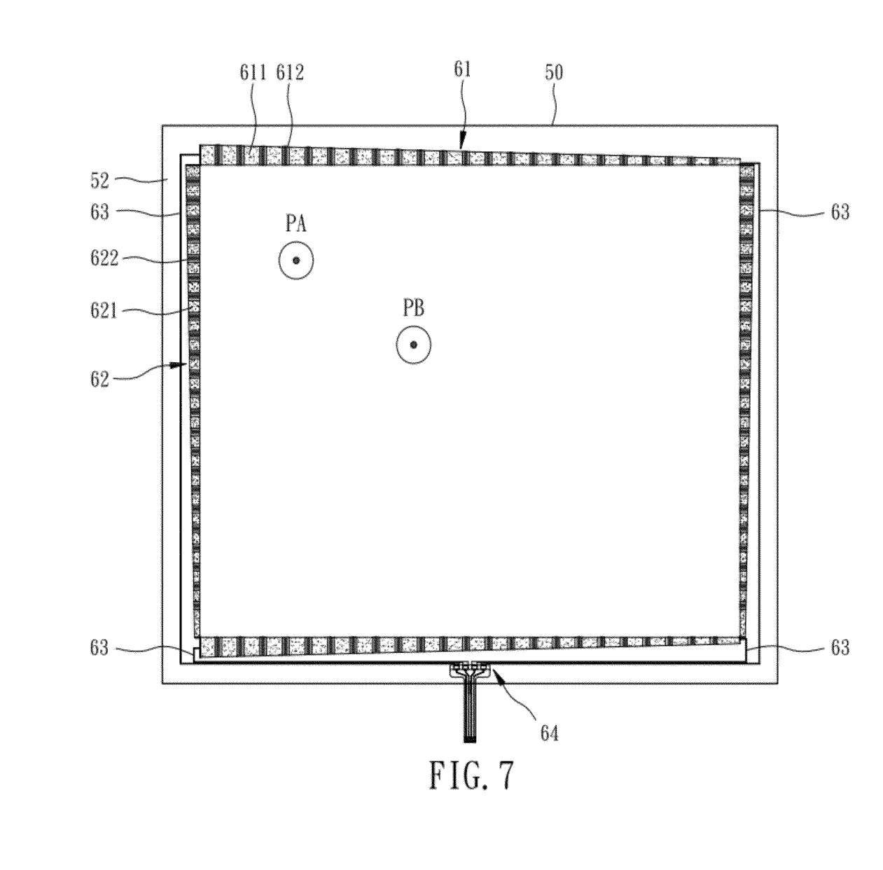

FIG. 7 shows the actual operation of the invention. As shown in FIG. 7, four corners of the X-side and Y-side electrodes 61 and 62 of the electrode pattern layer 60 of the touch panel 50 are connected to four external wires 63 to receive AC sensing signals, respectively, for the measurement of the positions of the two different touch points PA and PB on the touch panel 50.

Regarding the operation, the system generates the nonuniform electric field on the transparent electroconductive layer 52 of the touch panel 50. When the finger touches the touch panel 50, the capacitor charging effect appears, so that the capacitor coupling is formed between the finger and each of the X-side and Y-side electrodes 61 and 62 on the electrode pattern layer 60 of the touch panel 50, and the capacitor change is generated. The controller measures the current intensities at the four corners in this way, and the impedances of the X-side and Y-side electrodes 61 and 62 of the electrode pattern layer 60 are configured in an ascending manner or a descending manner with a common difference or a common ratio toward the same side, so that the impedances of two touch points PA and PB on the same horizontal or vertical line on the touch panel 50 have the gradient phenomenon. Thus, it is possible to prevent currents, outputted from the electrode pattern layer 60, from offsetting each other when the two touch points PA and PB are moved. Thus, the positions of the two different touch points PA and PB can be calculated according to the currents so that the controller can determine the subsequent scaling, rotating or dragging operation to satisfy the requirement of the multiple touch points of the surface capacitive touch panel. In addition, the constitution and the manufacturing difficulty of the multi-point touch panel can be significantly simplified.

The impedance adjustments of the X-side and Y-side electrodes 61, 62 of the electrode pattern layer 60 are performed through the carbon paste sections 611, 621 and the silver paste sections 612, 622 arranged in the neighboring manner. Thus, the touch panel 50 of the invention can perform the specific impedance adjustment on the X-side and Y-side electrodes 61, 62 of the electrode pattern layer 60 according to the special requirement in the used environment. Thus, the touch panel 50 can hold the consistency and stability of the sensitivity of the touch point, so that the precision of the detected position of the touch point of the touch panel 50 is enhanced.

Furthermore, the electrode pattern layer 60 of the touch panel 50 of the invention may have the impedance adjustment using the simplest printing technology so that the manufacturing processes are significantly simplified. Compared with the prior art, the manufacturing cost thereof may be effectively reduced so that the added value and the economic effectiveness of the product are further enhanced. Thus, the invention provides an impedance adjusting method for the surface capacitive touch panel. The method includes the step of arranging one carbon paste section and one silver paste section or carbon paste sections and silver paste sections in a neighboring manner to adjust each of impedances of the X-side and Y-side electrodes.

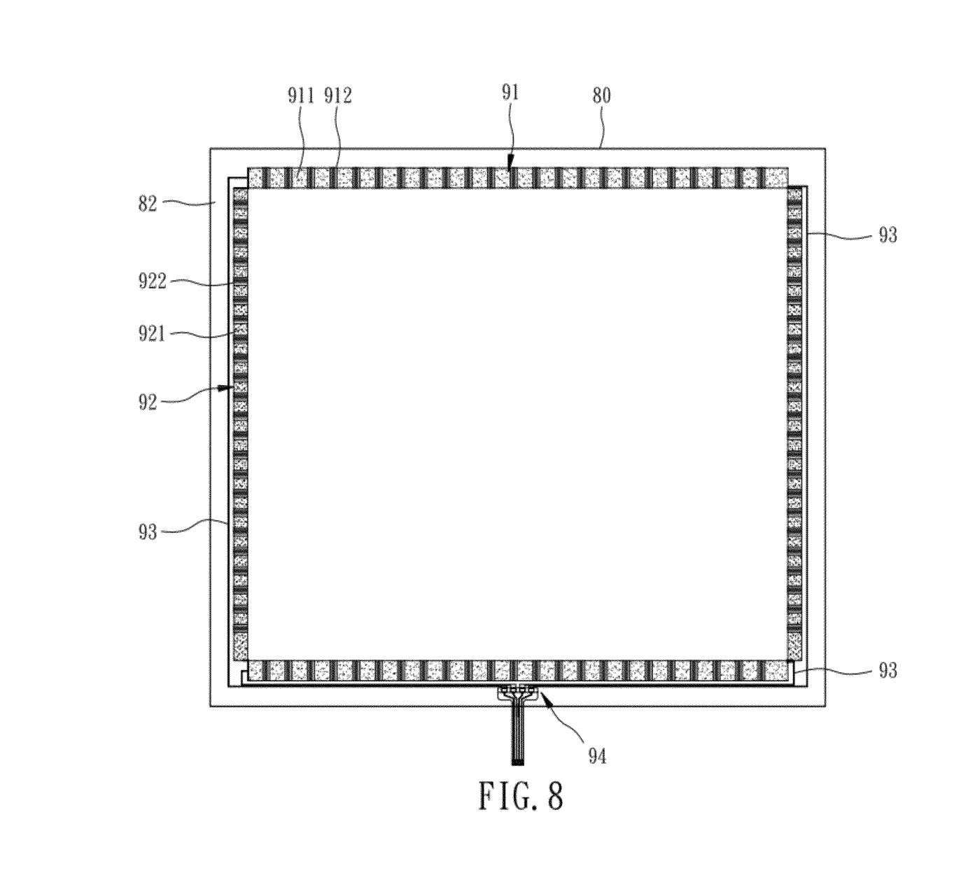

Also, the touch panel 50 of the invention may be modified into a touch panel 80 shown in FIG. 8 according to another embodiment. The touch panel 80 adopts the surface capacitive touch technology and includes a transparent substrate 81, a transparent electroconductive layer 82, an electrode pattern layer 90 and a protection layer 85 stacked together. The electrode pattern layer 90 includes two opposite X-side electrodes 91 and two opposite Y-side electrodes 92, which surround a rectangular area and are formed on a periphery portion of the transparent electroconductive layer 82. Each of the two X-side electrodes 91 and the two Y-side electrodes 92 of the electrode pattern layer 90 has the uniform width (while the electrode 61/62 has the increasing width). Furthermore, the X-side and Y-side electrodes 91, 92 of the electrode pattern layer 90 include one or more carbon paste sections 911, 921 and one or more silver paste sections 912, 922 arranged in a neighboring manner. The spaced carbon paste sections 911, 921 and the spaced silver paste sections 912, 922 may be spaced apart by constant gaps. The spaced carbon paste sections 911, 921 are configured in an ascending manner or a descending manner with a common difference or a common ratio, wherein the gaps between the carbon paste sections 911, 921 ascend or descend with the common difference or the common ratio. The spaced silver paste sections 912, 922 are configured in an ascending manner or a descending manner with a common difference or a common ratio, wherein the gaps between the carbon paste sections 911, 921 ascend or descend with the common difference or the common ratio. According to the design of the X-side and Y-side electrodes 91, 92, the specific impedance adjustment of the electrode pattern layer 90 of the touch panel 80 can be performed according to the special requirement in the used environment. Thus, the consistency and stability of the sensitivity of the touch point can be enhanced so that the precision of the detected point of the touch point of the touch panel is enhanced.

In addition, the corresponding terminals of the X-side and Y-side electrodes 91 and 92 of the electrode pattern layer 90 are commonly provided with wires 93 each for measuring the voltage and the current. The wire 93 is made of the electroconductive material, such as the carbon paste, the silver paste, the copper paste or the mixtures thereof. In this invention, the silver paste is adopted, and the wires 93 are disposed on the surface of the non-work area of the touch panel 80 by way of screen printing. Also, the touch panel 80 also has a connection portion 94 for the layout of the other-side terminals of the wires 93 so that the wires 93 can be respectively electrically connected to a controller (not shown) of the touch panel 80, and the same advantage and utility value may be obtained.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A touch panel with an impedance adjusting structure, the touch panel comprising a transparent substrate, a transparent electroconductive layer, an electrode pattern layer and a protection layer, all of which are stacked together, wherein:
the electrode pattern layer comprises two opposite parallel X-side electrodes and two opposite parallel Y-side electrodes, all of which surround a rectangular area and are formed on a periphery portion of the transparent electroconductive layer;
each of the X-side and Y-side electrodes is composed of one carbon paste section and one silver paste section, or carbon paste sections and silver paste sections arranged in a neighboring manner;
each of impedances of X-side and Y-side electrodes is adjusted according to a ratio of the carbon paste section(s) to the silver paste section(s); and
each of end portions of the X-side electrodes and Y-side electrodes is electrically connected to a wire for measuring an output current.

2. The touch panel according to claim 1, wherein the impedances of the X-side and Y-side electrodes of the electrode pattern layer are configured in an ascending manner or a descending manner with a common difference or a common ratio toward the same side, so that impedances of two touch points on the same horizontal or vertical line of the touch panel have a gradient phenomenon to prevent currents from offsetting each other when the two touch points are moved, and positions of the two different touch points are calculated according to the currents.

3. The touch panel according to claim 1, wherein the transparent substrate is a transparent glass substrate or transparent plastic or an indium tin oxide (ITO) electroconductive plastic film.

4. The touch panel according to claim 1, wherein the protection layer is a transparent insulative hard film, a mother glass film or a plastic film.

5. The touch panel according to claim 1, wherein the carbon paste sections of the X-side and Y-side electrodes are arranged in an ascending manner or a descending manner with a common difference or a common ratio.

6. The touch panel according to claim 1, wherein the silver paste section of the X-side and Y-side electrodes are arranged in an ascending manner or a descending manner with a common difference or a common ratio.

7. An impedance adjusting method for a surface capacitive touch panel, the touch panel having a transparent substrate, a transparent electroconductive layer and an electrode pattern layer stacked together, wherein the electrode pattern layer comprises two opposite parallel X-side electrodes and two opposite parallel Y-side electrodes, all of which surround a rectangular area and are formed on a periphery portion of the transparent electroconductive layer, the method comprising:
arranging one carbon paste section and one silver paste section or carbon paste sections and silver paste sections in a neighboring manner to adjust each of impedances of the X-side and Y-side electrodes.

8. The method according to claim 7, wherein the impedances of the X-side and Y-side electrodes are configured in an ascending manner or a descending manner with a common difference or a common ratio toward the same side.

9. The method according to claim 7, wherein the carbon paste sections of the X-side and Y-side electrodes are arranged in an ascending manner or a descending manner with a common difference or a common ratio.

10. The method according to claim 7, wherein the silver paste section of the X-side and Y-side electrodes are arranged in an ascending manner or a descending manner with a common difference or a common ratio.
